(19) United States
(12) Patent Application Publication
(10) Pub. No.: US 2005/0268212 A1
(43) Pub. Date: Dec. 1, 2005

(54) System, apparatus, and method for desktop-based creation and publication of a periodic community newsletter

(76) Inventor: Michael Dagel, Dallas, TX (US)

Correspondence Address: VESNA N. RAFATY, ATTORNEY & COUNSELOR, 18926 CAMPBELL ROAD, DALLAS, TX, 75252, US

(21) Appl. No.: 11/139,173

(22) Filed: May 28, 2005

Related U.S. Application Data
(60) Provisional application No. 60/575,547, filed on May 28, 2004.

(51) Int. Cl. G06F 17/00

(52) U.S. Cl. 715/500; 715/517; 707/1; 715/764

(57) ABSTRACT

A user-interactive apparatus for the desktop-based creation and publication of a periodic community newsletter wherein at least some of the content is presented to the user in the form of a pre-defined searchable database containing user-modifiable content relating to subject matter of interest to the community. A system and method for a user's desktop-based creation of a print order for a periodic community newsletter and subsequent processing of the newsletter order by a publisher entity.

CLAIM OF PRIORITY THIS NON-PROVISIONAL PATENT APPLICATION CLAIMS PRIORITY TO PROVISIONAL PATENT APPLICATION NO. 60/575,547 FILED ON MAY 28, 2004. This non-provisional patent application incorporates by reference the entire content of Provisional Patent Application No. 60/575,547.

COPYRIGHT NOTICE: The applicant claims copyright ownership of and reserves all rights in certain content as specified in Section V below.

### BACKGROUND OF THE INVENTION

Many apartment management companies disseminate periodic newsletters to their residents. Such newsletters communicate information of general interest to residents. Often the management companies are not staffed to support the ongoing task of authoring and publishing such newsletters. One business model has emerged to meet this need: the management company outsources the publishing of the newsletter to a service which accepts newsletter orders, processes the orders, and ships printed newsletters directly to the apartment communities managed by the management company. To facilitate the process, the publisher gives clients access to a catalogue of pre-written articles which treat topics which are of general interest to residents in apartment communities. The client selects articles for its newsletter order and gives instructions to the publisher how any given chosen content needs to be modified. This model is inefficient and requires the use of traditional purchase order processing tools, such as paper, telephone, facsimile and mail.

What is needed is a user-friendly computer-implemented apparatus for the efficient authoring and creation of periodic publications such as community newsletters by the user directly from the user's desktop with minimal external steps.

What is needed is an interactive computer-implemented tool which enables the user to readily create a community newsletter by selecting and modifying content presented by the computer-based application tool.

### SUMMARY OF THE INVENTION

The disclosed invention addresses the inherent inefficiencies of the traditional paper-based model described above for the creation of a print order for a community newsletter utilizing an outside publishing service.

The disclosed invention is directed to interactive tools for desktop-based, user-friendly, authoring, editing, capturing, print order generation, and distribution of periodic communications such as newsletters, bulletins, or other publications which utilize a standardized page-format and where at least some of the content is ready-made and presented to the user for selection and editing. More specifically, but not by way of limitation, the disclosed invention is directed to an interactive computer software tool for user-directed, desktop-based creation of an apartment community newsletter, including distribution of the newsletter over the Internet or an Intranet, or in the alternative, placement of a printing order for the newsletter with a publisher who will complete order fulfillment steps outside of the disclosed application tool. It should be noted that the term “apartment” herein refers to any type of managed residential community such as but not limited to an apartment complex, nursing home, assisted living center, and condominium.

While the preferred embodiment of the disclosed invention is for apartment community newsletters, it will be obvious to one of ordinary skill in the art that the disclosed apparatus, system, and method may be used for the user-controlled, desktop based creation and distribution of periodic publications in various other industries. In short, the disclosed method is applicable to any situation where the user has a need to communicate at a periodic frequency with a community of target readers via a short publication utilizing a somewhat standardized format of variable content where there is an available ready-made pool of relevant content. Thus, by way of example only, the disclosed system and method are applicable to company in-house newsletters in limitless industries.

The steps in the preferred embodiment where the periodic publication is an apartment community newsletter are summarized below. A prototype of the preferred embodiment was developed after a number of years of experience publishing newsletters for apartment communities using the traditional non-computer-based business model described above. Per the disclosed invention, ‘user’ is a term used to refer to the individual who uses the disclosed application tool to create a newsletter at his/her desktop and then distributes the newsletter per the methods described herein. The term “publisher/host” is used herein to refer to a person or entity that accepts and fulfills orders for a newsletter specified using the application tool described herein and creates and manages the databases that comprise the application tool.

The application tool of the disclosed invention prompts the user through a series of user-friendly screens which represent templates for data entry. The information input is that required to fully specify, generate, and transmit to an outside publisher a print order for a customized periodic apartment community newsletter having a standardized format described below. The application program has built-in controls which prompt the user to input all required data before completion of the order. On each screen, the user may exit the application (by clicking the “EXIT” key) or seek help from the publisher/host by clicking the “CONTACT” key. A key feature of the application tool is that the user is given access to application tool predefined databases which contain relevant content of text and graphics. The user can search the databases, select content, and modify selected content for use in the newsletter. A time-saving feature of the preferred embodiment is a one-click option whereby, during the content specification steps, with one click the user may authorize the publisher/host to independently select content from the databases for the user's current order. An alternative version of the preferred embodiment, which does not include a publisher/host entity, is a computer-implemented, web-based method for enabling the user to independently specify and generate a periodic newsletter for distribution over the Internet to target readers via an electronic mail distribution list created and managed by the user.

The specific format for the newsletter per the preferred embodiment is a four-page flyer where each page is the standard size of 8.5″×11″. Page 1 has a graphic header on top identifying the apartment community. The body of Page 1 is comprised of a number of very paragraph-length articles on various topics of current interest to apartment communities The vertical right margin of Page 1 is a section containing contact information including telephone numbers for the administrative staff of the apartment community. Inside facing pages, Pages 2 and 3, contain articles on various topics. Page 4 has a top half section which has either articles or billboard. The bottom half of Page 4 is a monthly calendar. Under the preferred embodiment, the user is able to customize content only on Pages 1 and 4, the outside facing pages of the newsletter. Limiting the pages where the user may select and modify content greatly expedites the order process and reduces the time the user spends on specifying the newsletter. Numerous alternative formats for the newsletter are possible and are within the scope of this invention. As an example and not by way of a limitation, a one-page newsletter containing content printed on both sides of the page is within the scope of the disclosed invention.

The application tool prompts the user to manually input, update as appropriate, and review certain information, herein broadly referred to as order attributes, required for generating a printing order for a periodic newsletter. Information to be input and/or updated includes order shipping information, billing information, management company information, and newsletter publication frequency. As a time-saving feature, the application tool automatically displays order attributes data from the previous order placed by the user for the specified property. To facilitate the data entry process, a RESET key is provided which enables the user to erase all entries on the screen and start over. First time users of the application tool are required to review and accept an electronic document which represents the publisher/host's Service and Billing Terms Agreement. To complete the order, an authorized agent's signature is required on the Service and Billing Terms Agreement.

When updating the management company information, the user names each apartment community managed by the management company. If the management company provides management services to more than one apartment community, then the application tool automatically applies a multiple-property discount to the print order. The application tool prompts the user to specify “regular handling” or “priority handling” for the order. The output of the data entry steps is a sample invoice which the user may print as a hard copy. In the sample invoice screen the user is prompted to add sales tax as appropriate. The user must either accept or revise the invoice displayed.

The user may specify monthly, bimonthly, or one of several quarterly options for the newsletter frequency.

The application tool next prompts the user to select and customize certain content for the newsletter. The application tool has a feature whereby the user can, with a single click on “EZ ORDER” displayed on the screen authorize e publisher/host to independently select and specify content for all pages of the newsletter. This is a time-saving feature for the user.

The user who does not exercise the EZ ORDER option, is prompted by the application tool to “Build Your Newsletter,” i.e., select content for Pages 1 and 4 of the newsletter. The user may choose to specify content for Pages 1 and 4 in any order he/she prefers. So, for example, the user may elect to specify content for Page 4 before specifying content for Page 1.

The application tool automatically formats the header contained on Page 1 of the newsletter to incorporate the graphic of the property logo specified by the user. The user next inputs and/or updates (for all orders after the first order) the staff listing and office hours which information will be contained in the right vertical margin of Page 1 of the newsletter. The user may elect to show the 911 emergency contact information in addition to the other contact information by simply clicking on the “911” displayed on the screen. Having specified content for the right margin of Page 1, the user next may select articles for the body of Page 1 from an Articles Database. The Articles Database contains textual content, i.e., short articles, organized into Categories and Subcategories within Categories. To view an article, the user must select from the listing displayed by the application tool both an article Category and article Subcategory. Alternatively, the user may search the Articles Database by typing a search keyword. A listing of article titles which are in the selected category/sub category or which satisfy the keyword search is displayed. When the user clicks on a highlighted article title, the program displays the text of that article in a box where the user may modify the content or accept the content as is. The user effectively selects an article for inclusion in the current newsletter order by clicking on “SAVE.”

Another user-friendly feature of the Application Tool program is a Line Count Indicator Table which displays to the user the following information: the total number of lines available for the particular page, the number of lines filled by the user specified content, and the number of lines remaining into which the user may add additional content.

Having specified content for Page 1, the user may now specify content for page 4 which is formatted into a top half of the page and a bottom half of the page. Per the preferred embodiment, the top half may be, at the user's election, either articles selected from the Articles Database or a graphic herein called a “Billboard” selected from the Billboard Database. The bottom half of Page 4 of the preferred embodiment for the newsletter is the monthly calendar for the issue month of the newsletter. The user may click on any of the day-boxes of the calendar and input information for that day such as but not limited to events, activities, and/or special greetings. Alternatively, by clicking on “Fun Calendar” the user selects any of the application tool pre-defined standard calendars for that month.

### BRIEF DESCRIPTION OF DRAWINGS

FIG. 1 is a block diagram showing the major components of the disclosed system for creation of a newsletter order involving a publisher/host;

FIG. 2 is a block diagram showing an alternative, web-based, embodiment of the disclosed invention where the user-publisher distributes the newsletter directly to subscribers via electronic mail;

FIG. 3 is an entity-relationship diagram showing the major entities and their interrelationships per the disclosed invention;

FIG. 4 is a process flowchart showing program steps of the Application Tool per the preferred embodiment for a four-page community newsletter;

FIG. 5 is a process flowchart showing steps taken by the publisher/host to finish the order per the non web-based system disclosed;

FIGS. 6-12 show sample data screens of a prototype application tool developed for the preferred embodiment for a 4-page apartment community newsletter

### DETAILED DESCRIPTION OF THE DRAWINGS

The disclosed invention is directed to a computer-based system, apparatus, and method for the authoring of a formatted periodic community newsletter by a user directly from his/her desktop using at least some content which is selected and modified (if desired) by the user from an application-pre-defined database of relevant content. The disclosed invention is also directed to the computer-based generation and processing of a print order for a formatted community newsletter authored using the disclosed application tool. The scope of the disclosed invention includes the publication via the Internet or an Intranet of the newsletter created using the disclosed application tool.

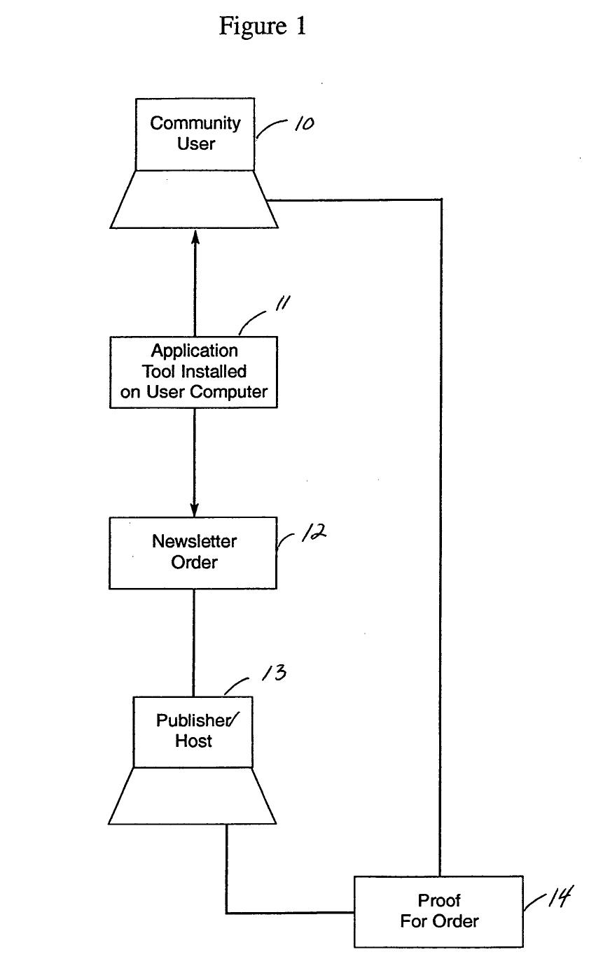

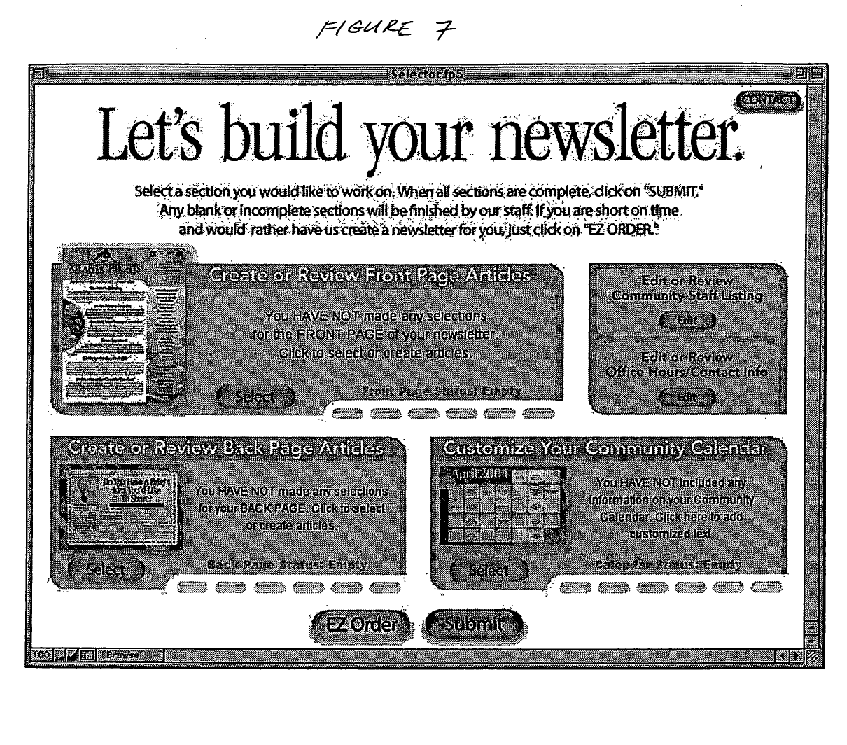

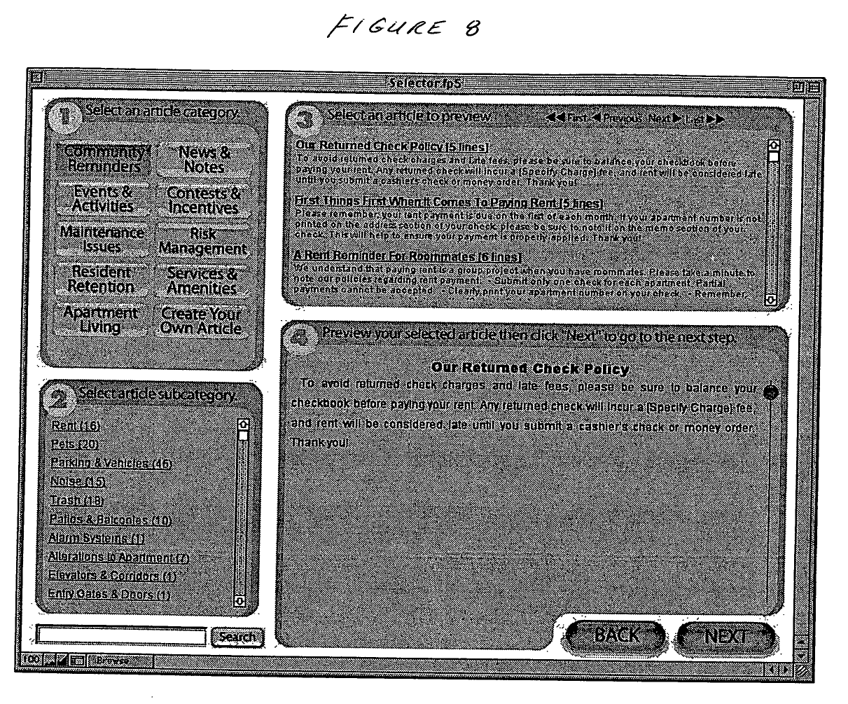

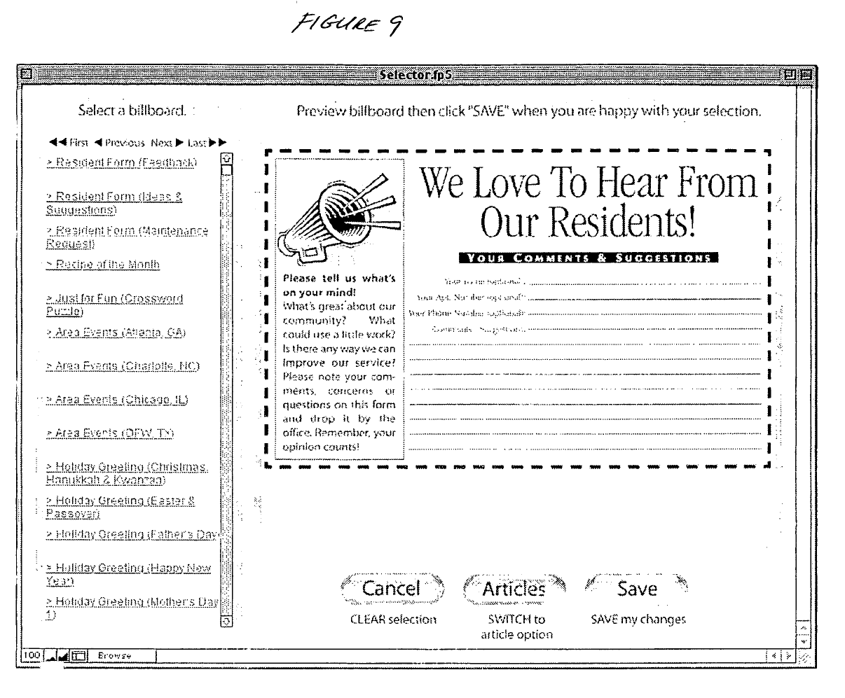

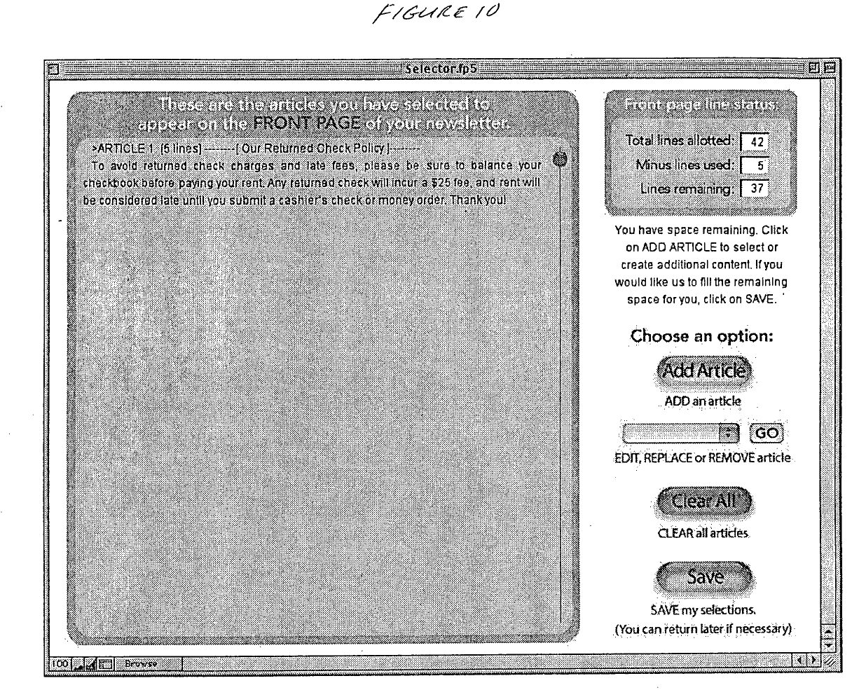

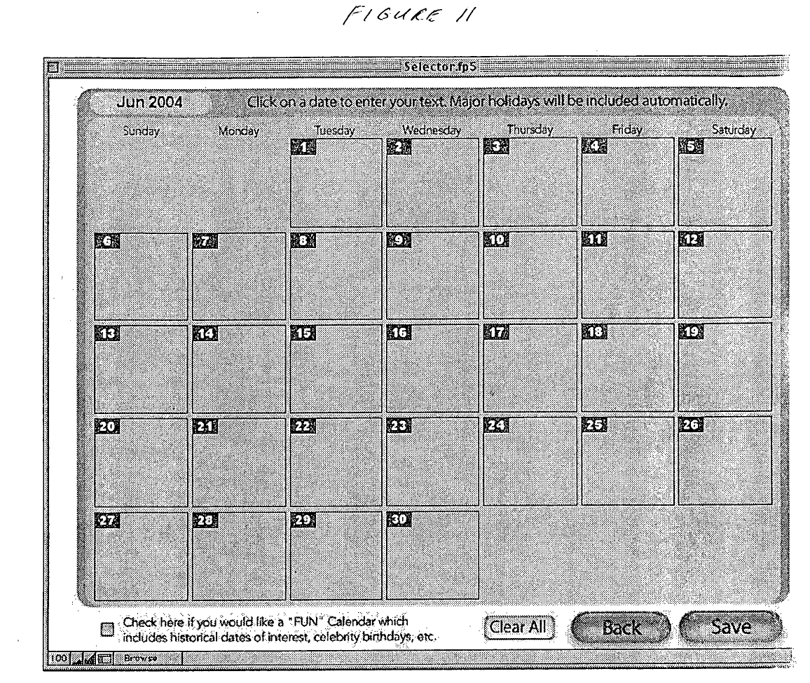

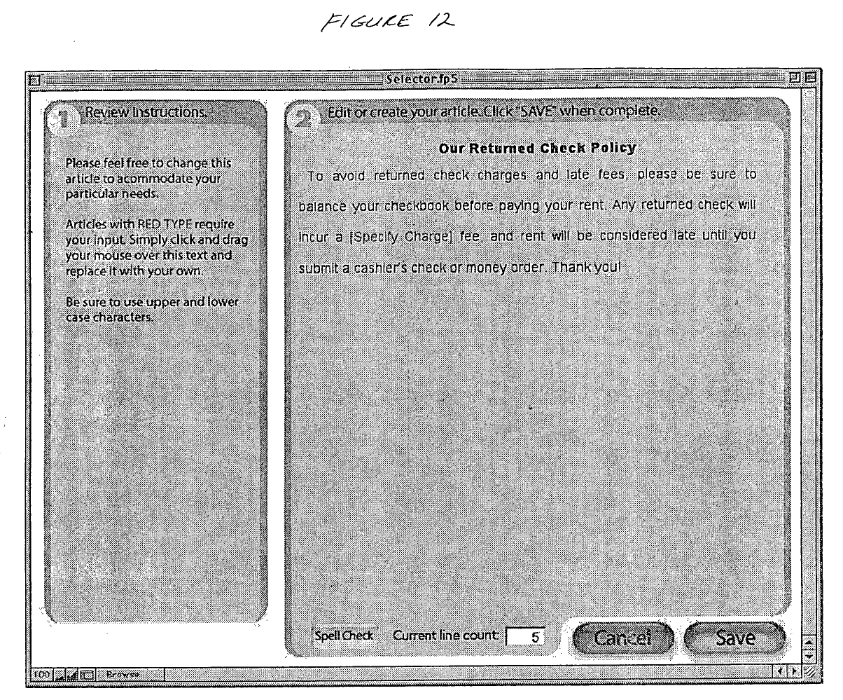

The reader will be able to more readily grasp the disclosed invention by reference to the drawings per FIGS. 1 through 12 discussed in detail below. The discussion below focuses on the functionalities of the various disclosed entities, including the Application Tool. It will be obvious to one of ordinary skill in the programming art how to develop code to achieve the disclosed functionalities. The applicant has reduced the disclosed invention to practice in the form of a working prototype Application Tool and Assembly Database required to practice the preferred embodiment of the disclosed invention.

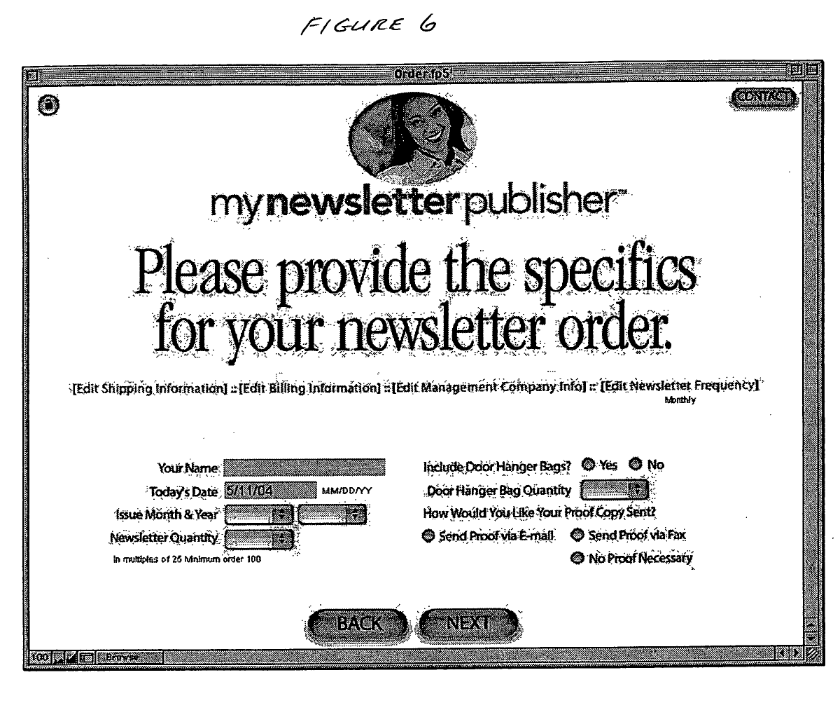

The reader is advised that certain content disclosed below, especially content per FIGS. 6 through 12, is copyright protected and the applicant hereby reserves all rights therein. Moreover, the applicant asserts trade dress protection for the sample data screens as disclosed in FIGS. 7 through 12.

FIG. 1 is a block diagram which shows the major components in the disclosed system where a publisher/host processes the newsletter order created by the community user with the aid of the Application Tool. Community User Computer 10 is equipped with an Internet connection and a browser. The community user installs the Application Tool 11 onto Community User Computer 10. The output of the Application Tool 11 is a fully-specified Newsletter Order 12 which the community user communicates to the publisher/host via facsimile or via electronic mail to the Publisher/Host Computer 13 (as shown) which is also equipped with an Internet connection. If the Newsletter Order 12 includes a request for a proof, the publisher/host sends a Proof 14 to the community user for review and approval. The publisher/host prints the newsletters per the approved proof and distributes the finished order to the address specified by the community user.

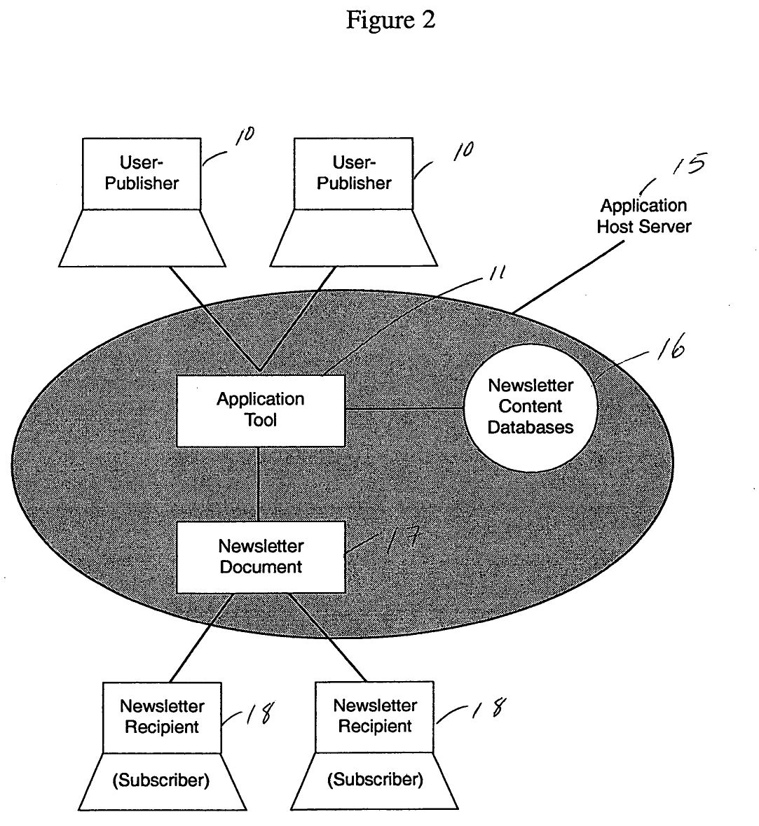

FIG. 2 is a block diagram showing an alternative embodiment of the disclosed system which is web-based and allows the community user to publish the newsletter in electronic form over the Internet without the need for a third party publisher/host. Using the browser on Community User Computer 10, the community user accesses and runs the Application Tool 11 which resides on the Application Host Server 15. Application Tool 11 gives the user access to Newsletter Content Databases 1 6 which reside on the Host Application Server 15 and which are updated and managed by the application host entity. The Application Tool 11 generates a Newsletter Document 17 in electronic form which the user-publisher can directly send as an electronic mail transmission to Subscribers 18.

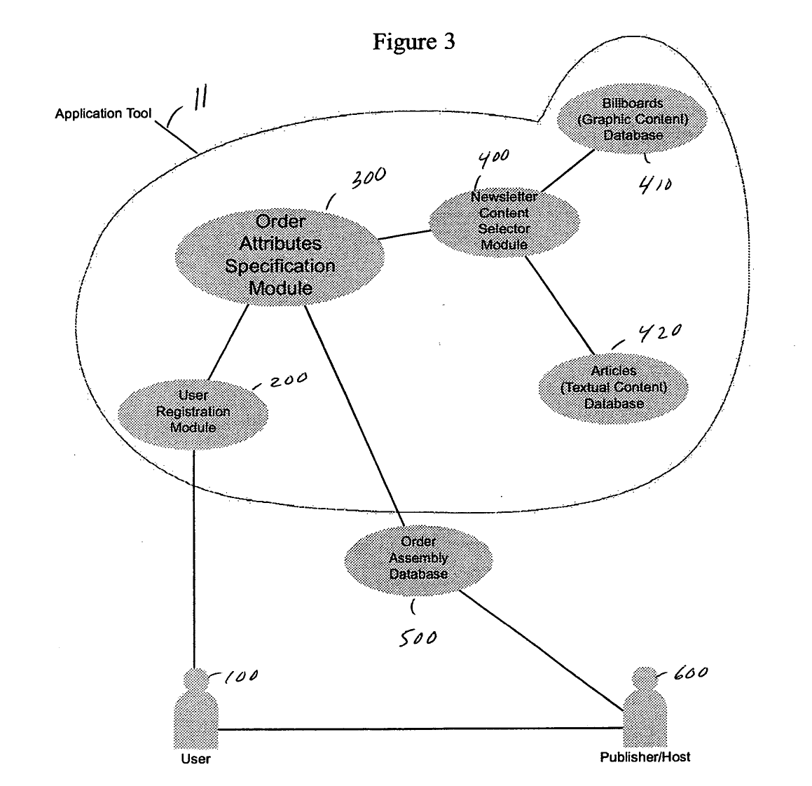

FIG. 3 is an entity-relationship diagram which depicts the major entities and their interaction per the non web-based preferred embodiment (see FIG. 1) of the disclosed invention. To keep the diagram simple and easier to follow, the various data entities which comprise the various entities of the Application Tool 11 are not shown. The community user's 100 interface with the Application Tool 11 begins with the User Registration Module 200 where the community user 100 inputs community user identifying information. Note that in alternative designs of the disclosed system, the User Registration Module may not be a separate entity but may simply be a part of the Order Attributes Specification Module. The next user interface is the Order Attributes Specification Module 300 wherein the community user inputs order-specific data attributes, other than newsletter content. The Order Attributes Specification Module 300 is directly connected to the Newsletter Content Selector Module 400 where the community user 100 is prompted through a series of data entry screens to select and specify content for pages 1 and 4 of the newsletter. The Newsletter Content Selector Module 400 has direct connections to two databases, namely the Billboards Database 410 and the Articles Database 420. The publisher/host 600 interface with the Application Tool 11 is by way of the Order Assembly Database 500 which receives and processes the newsletter order from the Order Attributes Specification Module 300.

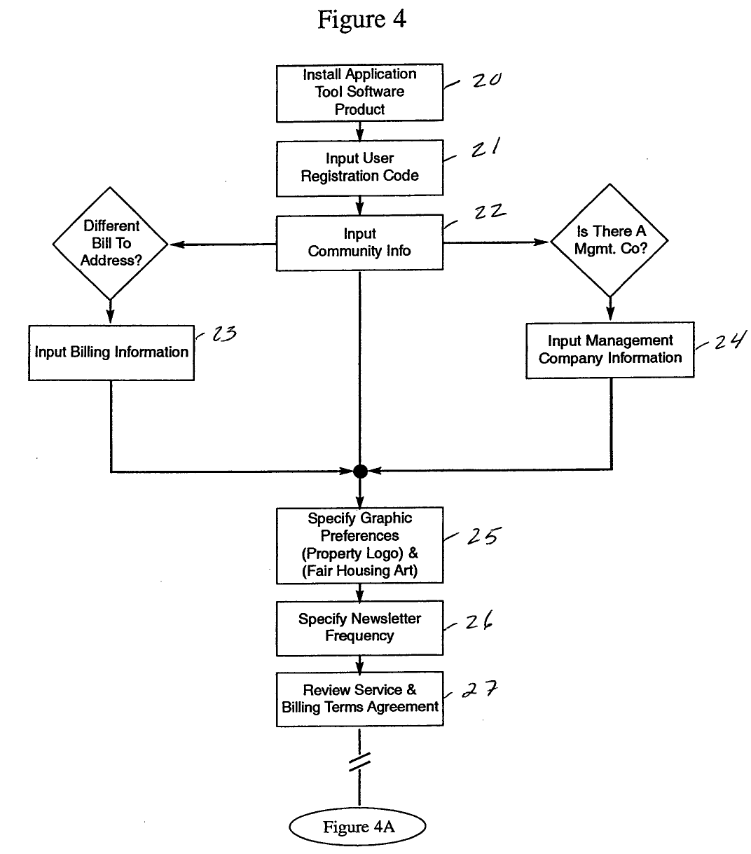

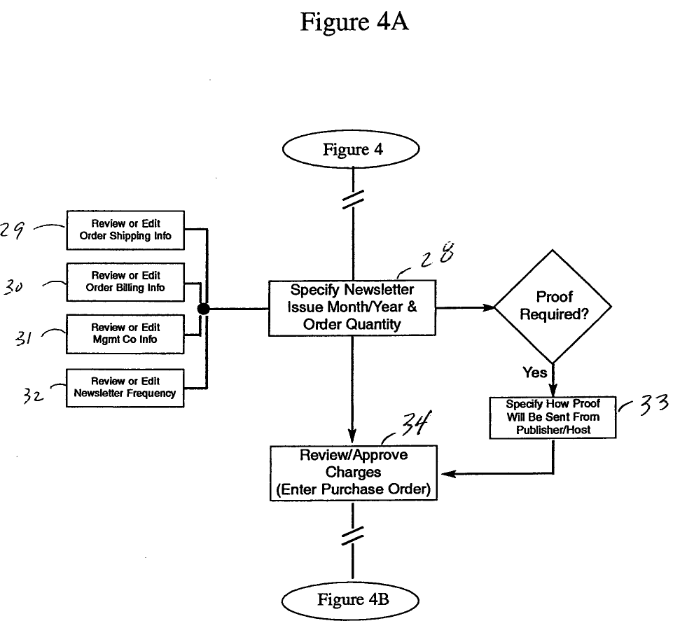

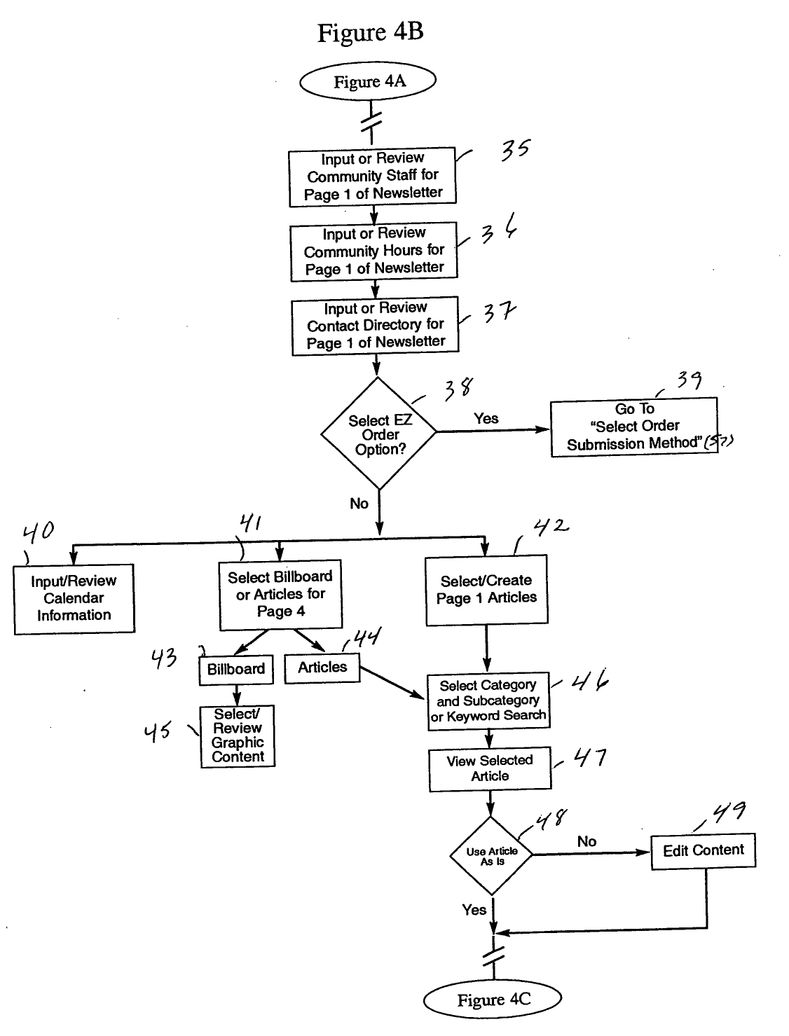

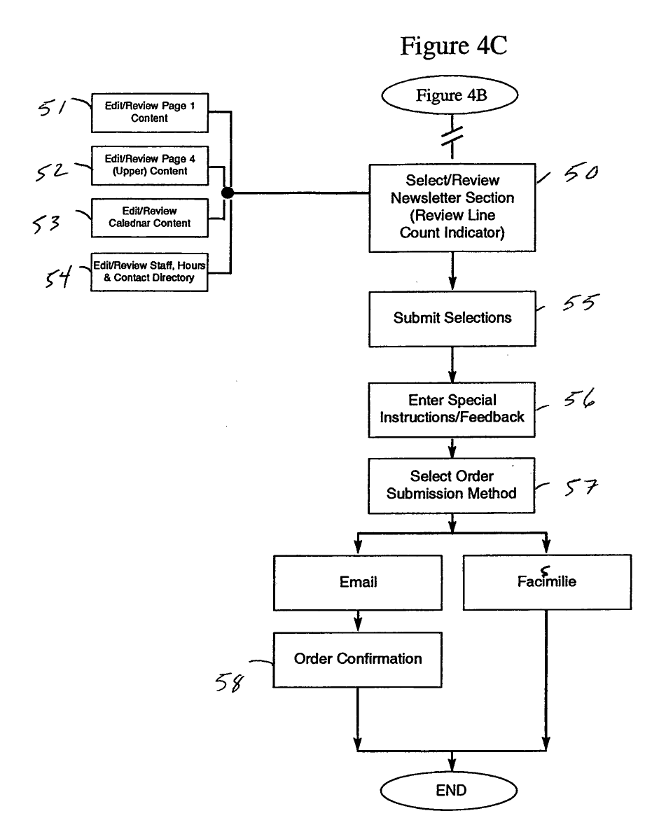

FIGS. 4, 4A, 4B, and 4C are detailed process flowcharts showing program steps and/or user interface steps for a prototype Application Tool 11 developed by the Applicant for the preferred embodiment for a four-page community newsletter where a publisher/host completes the application-tool generated newsletter order in post-application tool processing steps. Note that the disclosed process is user-driven, i.e., for a newsletter order to be created, the user must follow the steps per the Application Tool. Under the disclosed system which uses a publisher/host, the publisher/host may directly contact the user (e.g., via telephone or e-mail) to remind the user that it is time to place an order for the next issue of the newsletter. Alternatively, the Application Tool may be programmed to have an additional feature (not shown in FIG. 4) as follows: Each time the user starts up the Application Tool program, the program displays to the user the issue month of the last placed order and the suggested timeframe to place the next order based on the previously-input order frequency. This feature helps the user manage the newsletter ordering process and is helpful when more than one individual at the apartment community is responsible for placing newsletter orders using the Application Tool. It is also noted that at any point in the process described in FIGS. 4, 4A, 4B, and 4C the user may leave the program by clicking on the EXIT tab on the display screen. Clicking EXIT means the Application Tool will save the data (user attributes, order attributes, content selection data ) input by the user during that session.

Per FIG. 4, the community user begins the disclosed process by installing the Application Tool software product onto his/her personal computer which has a browser installed and has an Internet connection. The user is prompted to input the unique Registration Number which is provided with the CD for the Application Tool software product purchased. Next, the user is prompted to input identifying information about the community including property name, address, telephone number, e-mail address, total number of units, billing address, and information on the management company if the property is not owner-managed. The user next specifies the logo to be used to identify the property in the newsletter. If the property has a logo, the user is prompted to mail a print of the logo directly to the publisher/host. If the property does not have a unique logo, then the user selects a typestyle for the logo from a number of application tool-provided typestyle options. Once the user has specified a property logo, the Application Tool (per the Order Assembly Database of FIG. 3 and discussed below) will automatically place that logo on the header section of Page 1 of the newsletter. As another feature, the user may select a statement related to the Fair Housing Act from a number of application tool provided optional statements for inclusion on Page 1 of the newsletter. The user specifies the preferred publishing frequency for the newsletter from a number of options including monthly, bi-monthly (even or odd-numbered calendar months), and quarterly (specifying the first, second, or third month of the quarter). The user is prompted to review an electronic document which represents the publisher/host's Service and Billing Terms Agreement. The publisher/host will not process the newsletter order unless the community user has sent to the publisher/host a signed Service and Billing Terms Agreement.

FIG. 4A shows the steps whereby the user inputs some final order-specific data attributes before any newsletter content has been selected (other than the property logo and the Fair Housing statements per above). Per Steps 29-32, the user may review and/or edit the previously-input data regarding shipping, billing, management company, and order frequency. The user also is prompted to input the following information about the order: whether the newsletter should be shipped with door hanger bags and if yes, the bag quantity, the issue month and year for the specific order being created, and an indication whether a proof is required from the publisher/host, and the method by which the publisher/host should send the proof to the user. If the user requests a proof via e-mail, then the application tool will ask the user to input an e-mail address if one was not entered in Step 22 above. Based on the issue month specified by the user, the application tool determines whether priority handling is required and whether priority handling is available for that order. If priority handling is available, the application tool will display a message highlighting that priority handling is available and the order surcharge for the priority handling. As a final step before the Newsletter Content Selector Module, the application tool displays a sample invoice for the order. The invoice shows the quantity of newsletters, the newsletter description as issue month and year, the charge (automatically calculated by the Application Tool based on publisher/host's pre-set rates), estimated shipping and handling charges, and a total amount for the invoice. If a purchase order number is required for the order, the user is prompted to input the purchase order number on the sample invoice screen. The user may “REVISE” or “ACCEPT” the purchase order as is. If the user wishes to revise the order, the application tool displays a previous screen wherein the user may input new order data attributes and go through Step 28 again. The user may print the sample invoice and walk it to management to secure in-house approval to proceed with the particular newsletter order.

FIGS. 4B and 4C show the user interface and application tool program steps which comprise the Newsletter Content Selector Module portion of the Application Tool. The user is prompted to input and/or review/edit certain information which will be automatically placed by the Order Assembly Database into the right margin column portion of Page 1 of the newsletter. In Step 35 per FIG. 4B, the user is prompted to input names of community staff members (in a user-preferred order) and their titles. To minimize keystrokes, the application tool displays some possible titles which are commonly-used in apartment community organizations. Next, in Step 36, the user is prompted to input office hours for each day of the week. Where the office hours are the same for each day of the week, the user may click on “Auto Fill” to specify office hours for the week with a single click after inputting office hours for one day of the week. In Step 37 per FIG. 4B, the user inputs contact information for the community which will also appear in the right margin on Page 1 of the newsletter. For illustration purposes, contact information may include e-mail addresses and telephone numbers for the office, courtesy patrol, maintenance, and emergency contacts. For each of the data inputs just discussed (staff member listing, office hours, contact directory), the application tool displays on the right side of the data entry screen a sample of how the information will appear in the right margin of Page 1 of the newsletter.

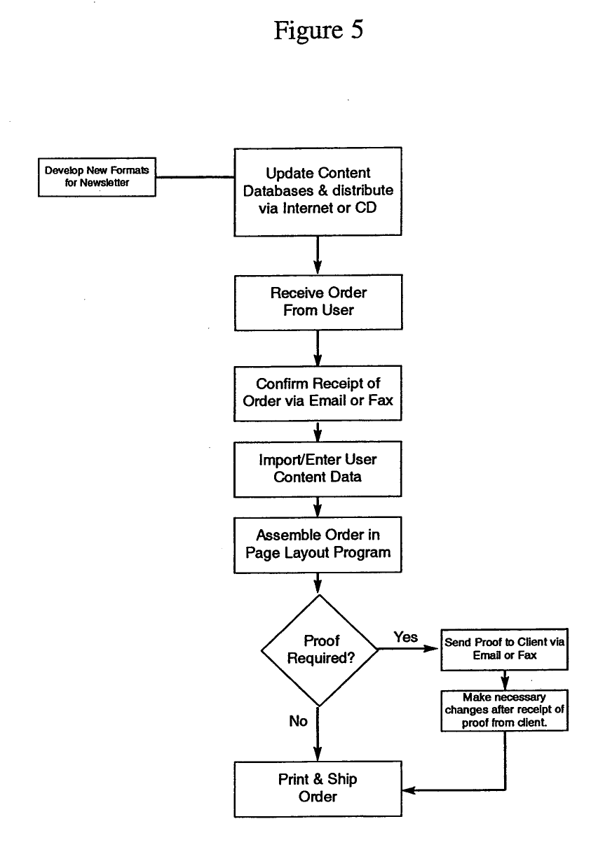

A useful feature of the Application Tool is called the “EZ Order” Option shown in Step 38 of FIG. 4B. By clicking on the EZ Order key displayed on the screen, the user authorizes the publisher/host to specify all of the remaining content for the newsletter, namely content for Page 1 articles, Page 4 content, as well as content for the internal Pages 2 and 3. Under the EZ Order Option, the publisher/host uses the Newsletter Content Selector Module of the Application Tool program to build the newsletter. It should be noted that in all cases, irrespective of whether the user has selected the EZ Order Option, content for internal pages 2 and 3 of the newsletter per the preferred embodiment is fully specified by the publisher/host in post-application tool steps performed by the publisher/host per FIG. 5 discussed below. Notwithstanding the latter, alternative embodiments of the Application Tool which allow the user to also specify content for the internal pages 2 and 3 of the newsletter are within the scope of the disclosed invention.

The user who does not select the EZ Order Option and chooses instead to use the Application Tool to customize content for the newsletter, can choose to specify content for the following in any order: calendar that will appear on the bottom of Page 4 (see Step 40 per FIG. 4B), billboard graphic or articles for the top-half of Page 4 (see Step 41 per FIG. 4B), and/or Page 1 articles (see Step 42 per FIG. 4B).

In Step 40 per FIG. 4B, when the user selects “Customize Your Community Calendar” from the “Let's Build Your Newsletter” screen, the Application Tool automatically displays the calendar for the issue month specified in the order. To input information for a particular day of the month, the user clicks on the number which represents the day of the month and inputs desired information into the box that is displayed. The application tool automatically inputs holidays for the given month. The user may also select the “Fun Calendar” feature whereby the Application Tool automatically inputs certain predefined information such as historical dates of interest and celebrity birthdays into particular day boxes of the calendar.

In Step 41 per FIG. 4B, the user is given the option to select either a billboard or a textual article for the top half of Page 4 of the newsletter. The application tool informs the user that if the user selects articles, there are 20-25 lines available to be filled. If the user selects the billboard option, the Application Tool automatically displays a listing of billboard titles in the Billboards Database. To view a billboard, the user clicks on a billboard title. To select a billboard for inclusion in the newsletter, the user clicks on SAVE. If the user chooses to put articles instead of a billboard in the top half of Page 4, then the user follows Steps 46 through 49 as described in the discussion below on Step 42.

In Step 42 per FIG. 4B, the application tool informs the user that there are 38 to 42 lines of type available for the articles portion of Page 1. In order to input content for Page 1 of the newsletter, the user must first select an article category from the application tool-provided list of categories. Next, the user must select a subcategory from the displayed list of subcategories for the specified category. The application tool displays a number in parentheses next to the subcategory indicating the number of articles in the Articles Database which are in the given subcategory. Once the user selects a subcategory, the application tool automatically displays the articles which are in the specified subcategory. Next to the article title is a number indicating the number of lines of type in that article. The user selects an article by clicking on the highlighted article title. The selected article next is displayed in a box in which the user is free to edit the article content as desired. The application tool displays a line usage counter which automatically adjusts the line count to reflect the actual number of lines in the article as modified by the user. The application tool has a customization feature whereby the article's customizable text is displayed in red and the user is prompted to modify that content. Alternatively, the user may search the Articles Database by typing a keyword and the application tool will display an article title, if any, for an article in the Articles Database which contains the keyword (see discussion below on structure of the Articles Database). To select the article text (as is or as modified by the user) for inclusion in the newsletter, the user clicks on SAVE which is displayed on the screen. The user is then prompted to “Add Article” if there is available remaining space on Page 1 as reflected in the Line Count Usage Indicator Table.

FIG. 4C shows the order finishing steps taken by the user including submission of the order to the publisher/host. Thus, per Steps 50 through 54, the user may remove, edit, and/or replace all previously specified content for Pages 1 and Page 4 of the newsletter. Once the user is satisfied with the order as specified, the user is prompted in Step 57 per FIG. 4C to select an order submission method, whether via facsimile or via e-mail. Clicking on one of the submission method option keys effectively submits the order to the publisher/host. The application tool then notifies the user that the order has been sent, if submitted electronically and informs the user that the publisher/host will send an order confirmation (see FIG. 5 discussion below).

FIG. 5 is a process flowchart showing the functions performed by the publisher/host in steps which are external to the Application Tool and which are part of the disclosed non web-based system for creation and dissemination of periodic newsletters. The publisher/host manages the Articles Database and the Billboards Database by inputting (e.g., importing text and image files, respectively from another source) or deleting records therein to reflect updated tastes, interests, and market trends for the target newsletter readership. Under the non web-based model per FIG. 1, the publisher/host may periodically release new versions of the Application Tool on a CD-ROM which contains updated content databases. Under the web-based model per FIG. 2, the Host updates the content databases and publishes them on-line in real time such that the Application Tool user-publisher always has access only to the latest version of the databases. Another function of the publisher/host is to develop new standard formats for newsletters and modify the program in the Application Tool as appropriate to reflect the newly-developed newsletter formats. Alternative formats for periodic newsletters are within the scope of the disclosed invention.

The publisher/host performs all of the order processing functions. Thus, the publisher/host receives newsletter orders from users and confirms orders back to the users via e-mail or FAX. If the order is from a new user, the publisher/host assigns a new unique User Account Number (see discussion below on structure of the Order Assembly Database) which will be used to identify that user's particular page template file in the Order Assembly Database. If an order was submitted via FAX, the publisher/host manually inputs user specified order data into the Order Assembly Database on the Publisher/Host Computer. For orders submitted via e-mail, the publisher/host imports the order as a tab delimited text file into the Order Assembly Database. Via pre-set scripts, the Order Assembly Database automatically places the user specified content into the proper page layout for the particular user. For orders which specify the EZ Order Option, the publisher/host manually enters content selections for the newsletter using the Application Tool installed on the publisher/host computer. When the user has requested a proof, the publisher/host sends the proof as required and then adjusts the newsletter order using the Order Assembly Database based on user's changes on the proof. Upon receiving the user's approval to proceed, the order finishing steps performed by the publisher/host are order printing (in-house or using a third party printer), billing, and shipping the printed newsletters directly to the user-specified order shipping address.

FIGS. 6 through 12 show sample data entry screens of a prototype Application Tool developed for a four-page apartment community newsletter per the preferred embodiment. The reader is hereby expressly advised that the content per FIGS. 6 through 12 is copyright-protected and the applicant reserves all rights therein. FIG. 6 is a screen that is part of the Order Attributes Specification Module. FIGS. 7-12 are sample screens in the Newsletter Content Selector Module.

Following is a description of the structures of the major databases in the disclosed invention. The disclosed structures are for illustration purposes only, and are not be construed as limitations. It will be apparent to individuals of ordinary skill in the programming art that alternative database structures are possible.

The Articles Database contains many application tool pre-defined records where each record is a textual article. Under the non-web based model of FIG. 1, there is a fixed, pre-defined number of records in the Articles Database. Under the web-based model, however, the number of records in the Articles Database is dynamic because the application host can update the database at any time and the user will be able to access the most current Articles Database on the Application Server.

Per the preferred embodiment, each record in the Articles Database contains information in the following seven fields: Article Number, Category, Sub-category, Article Line Count, Article Title, Article Text, and Search Keywords. The purpose of the fields is to help the user to more efficiently browse through the Articles Database to identify and select articles for the customized newsletter.

The Article Number of the Articles Database is a unique identifier for each record in the database.

The Category field of the Articles Database refers to one of several application tool pre-defined descriptive terms which describe categories of possible subject matter for articles. By way of example only, and not by way of limitation, the Articles Database per the preferred embodiment has the following Categories: Community Reminders, News & Notes, Events & Activities, Contests & Incentives, Resident Retention, Maintenance Issues, Risk Management, and Apartment Living. The possible values for the Category field are as varied as the breadth of the subject matter of the newsletter and are within the scope of the disclosed invention.

The Sub Category field of the Articles Database refers to an application tool pre-defined descriptive term which more narrowly identifies the possible topics under a given Category. For any Category, any one of several values for the Sub Category field are possible.

The field called Article Line Count contains an application tool pre-defined number which equals the number of lines of text in the article per the given record. The Application Tool will use that number to keep track of line usage as the user builds the newsletter.

The Article Text field of the Articles Database contains the actual text of the article.

The field called Search Keywords in the Articles Database contains application-tool pre-determined words which a user is most likely to use when searching for the specific article containing the text per the Article Text field.

The Billboard Database has three fields: Billboard Number, Billboard Title, and Billboard Graphic. The Billboard Number is a unique identifier for each record. The Billboard Title contains a broad category as well as a subcategory which are descriptive of the billboard. A sample Billboard Title is as follows: Area Events/Dallas or Recipes/Thanksgiving or Holiday Greetings/Christmas. The actual image file for the billboard graphic is stored in the Billboard Graphic field.

The Order Assembly Database is organized into the following five parts: User Account Number, User Shipping, Billing, and Contact information, Front Page Articles, Back Page Articles, and Calendar Entries. Via assembly program scripts (using AppleScript or the like) executed on the Publisher/Host Computer, the user-specified order data are imported into the appropriate places in the user's unique Page Template File (a Quark Xpress file or the like). Alternatively, the publisher/host manually inputs the user-specified order data into the users' page template file. The User Account Number serves to uniquely identify the user's page template file. Front Page Articles refers to nine fields into which user specified Page 1 content is either imported automatically via scripts of the Order Assembly Database or manually input by the publisher/host. Back Page Articles refers to six fields into which the user specified Page 4 content is imported or manually input into the user's Page Template File. The Calendar Entries comprise 31 individual fields into which the user specified text is imported or manually input and then via a script formatted and placed into the calendar template portion of the user's Page Template File.

1) A computer program embodied in a computer-readable medium for creation of a periodic community newsletter from a user's desktop comprising an application tool, at least one content database comprising pre-defined content files each representing content relating to subject matter of interest to the community, an interface between the application tool and each content database, and an assembly database which interfaces with the application tool, wherein:
a. The application tool comprises instructions which prompt the user to input information per screen templates displayed to the user, which information comprises newsletter attributes and newsletter order attributes including newsletter publication frequency, page format, graphic for newsletter heading, and community identification;
b. The application tool comprises instructions which, via the interface between the application tool and each content database allow the user to access each content database and search, select, allocate to specific portions of the newsletter, and view content stored therein, and modify user-selected content as desired; and wherein
c. The assembly database comprises instructions whereby the computer program organizes the data input by the user per the application tool, allocates, compiles and displays the data and all user-selected content as a viewable, printable, fully-specified newsletter file representing all pages of the newsletter as specified by the user and which, as desired by the user, is suitable for transmission to a publisher entity as a proof for a print order for the newsletter.

2) The computer program per claim 1 further comprising application tool instructions which either prompt the user to send the viewable, printable, fully-specified newsletter file to a publisher entity for order finishing steps, which enable the user to directly publish the newsletter to target readers via electronic mail, or which automatically assign a URL address to the viewable, printable, fully-specified newsletter file.

3) The computer program per claim 1 wherein content stored in the content database comprises text files.

4) The computer program per claim 1 wherein content stored in the content database comprises image or graphics files.

5) The computer program per claim 1 wherein content stored in the content database comprises articles written by members of the community.

6) The computer program per claim 1 further comprising instructions in the application tool which allow the user to authorize a publisher entity to select a portion or all of the content for the newsletter.

7) The computer program per claim 1 further comprising a content database wherein each content file is identified via a title and an indicator of the number of lines comprising the content.

8) The computer program per claim 1 wherein page format for the newsletter is a four-page newsletter.

9) The computer program per claim 1 wherein content files stored in the content database comprise a graphic of a user-fillable calendar.

10) The computer program per claim 1 where the application tool comprises an instruction which enables the user to authorize a publisher to select from the content databases all of the content for the newsletter with one click.

11) A computer-based method for processing of a client-generated order for a periodic community newsletter by a publisher comprising the steps of:
a. Providing the computer program per claim 1 to clients for installation on client computers where the client is the user per claim 1;
b. Installing the computer program per claim 1 on a publisher computer;
c. Receiving from the client a file representing the newsletter order as specified by the client via the computer program per claim 1;
d. Reviewing the file representing the newsletter order as specified by the client and selecting and allocating content, as authorized by the client, per prompts in the assembly database of the computer program residing on the publisher computer, and
e. Conducting newsletter order finishing steps comprising printing the newsletter in the client-specified quantities and shipping the printed order to the client.

12) A periodic community newsletter which was created using the computer program per claim 1.

13) An Internet-based system for the creation of a periodic community newsletter by a user-publisher and publication of the newsletter by the user-publisher to newsletter subscribers comprising:
a. A user-publisher entity and a user-publisher computer equipped with a browser and an Internet connection;
b. A host entity and a host server equipped with a browser and an Internet connection;
c. A subscriber entity and a subscriber computer equipped with a browser and an Internet connection;
d. The application tool per the computer program per claim 1 residing on the host server;
e. The content database per the computer program per claim 1 residing on the host server wherein content is managed and updated by the host entity, and
f. The assembly database per claim 1 residing on the host server.
